(19) United States
(12) Patent Application Publication
(10) Pub. No.: US 2020/0056769 A1
(43) Pub. Date: Feb. 20, 2020

(54) Light Trap With Bluetooth Module Holder

(71) Applicant: ABL IP Holding LLC, Atlanta, GA (US)

(72) Inventors: Albert Tran, Lawrenceville, GA (US); Prashank Kansal, Norcross, GA (US)

(21) Appl. No.: 16/105,158

(22) Filed: Aug. 20, 2018

(51) Int. Cl. F21V 23/04; H04W 4/80; F21V 23/00

(52) U.S. Cl. CPC F21V 23/0435; F21Y 2115/10; F21V 23/009; H04W 4/80

(57) ABSTRACT

A light fixture includes a housing and a light trap. The light trap includes a wireless communication module support adapted to removably support a wireless communication module such as a Bluetooth Low Energy (BLE) module on the light trap. A retrofit kit for an existing light fixture includes a light trap and a wireless communication module. The light trap is adapted to span a gap between a housing and an optic of the existing light fixture and includes a wireless communication module support. The wireless communication module is removably supported by the wireless communication module on the light trap.

### FIELD OF THE INVENTION

This application relates to light fixtures and retrofit kits for light fixtures, and more particularly to light fixtures and retrofit kits with light traps for Bluetooth® modules or other kinds of modules.

### BACKGROUND

Many traditional light fixtures are not “smart” enabled, meaning that they are not connected to other devices or networks via different wireless protocols (e.g., Bluetooth®, Wi-Fi®, near field communication, LiFi, 3G, etc.) and as such cannot operate interactively and/or autonomously. Moreover, traditional light fixtures are often difficult to retrofit with Bluetooth or other wireless capabilities because such changes require modifying the light fixture in the field, which in most cases requires an inspector to be on site and approve the modifications. Therefore, there is still a need for a system that can provide for easy installation and/or retrofitting of a wireless communication module into a light fixture

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a light fixture includes a housing and a light trap supported on the housing. The light trap is adapted to span a gap between the housing and an optic of the light fixture and includes a wireless communication module support adapted to removably support a wireless communication module on the light trap.

In some aspects, the light trap includes a trim and a sidewall, the wireless communication module support is on the sidewall, and the trim at least partially covers the wireless communication module support and is adapted to at least partially overlap an edge of the optic. In various examples, the wireless communication module support includes a receiving slot defined on an inner surface of the sidewall and a securing arm extending from the inner surface of the sidewall. In certain examples, the securing arm is deflectable away from the receiving slot. In some examples, the wireless communication module support is adapted to support the wireless communication module such that an antenna of the wireless communication module is substantially perpendicular to the sidewall. In other examples, the wireless communication support is adapted to support the wireless communication module such that the antenna of the wireless communication module is at an angle or tilted relative to the sidewall, such as an angle less than 90 degrees and/or an angle greater than 90 degrees.

In various examples, the light fixture includes the wireless communication module, a pair of end plates, a light source on the housing between the end plates, and an optic supported between the end plates and above the light source. In certain cases, the light source comprises a plurality of light emitting diodes (LEDs). In various examples, the light trap is supported on between at least one end plate of the pair of end plates and the optic. In some aspects, the wireless communication module support is offset from an inner wall of the at least one end plate.

According to some embodiments, a light trap for a light fixture includes a sidewall having an inner surface, a trim extending away from the inner surface, and a wireless communication module support on the inner surface of the sidewall. The wireless communication module is adapted to support a wireless communication module, and is at least partially covered by the trim.

In certain examples, the wireless communication support includes a receiving slot defined on the inner surface of the sidewall and a securing arm extending from the inner surface of the sidewall. In some cases, the securing arm is deflectable away from the receiving slot. In various examples, the light trap is adapted to be positioned on the light fixture between an optic of the light fixture and a housing of the light fixture.

In various aspects, the wireless communication module support is adapted to support the wireless communication module such that an antenna of the wireless communication module is substantially perpendicular to the sidewall. The wireless communication support supports the wireless communication module such that the antenna is at various other angles in other examples, and need not be supported substantially perpendicular to the sidewall. In some examples, the sidewall, trim, and wireless communication module support are monolithically formed. In some cases, the trim extends a first distance away from the inner surface, the wireless communication module support includes a receiving slot that extends a second distance away from the inner surface, and the first distance is greater than the second distance.

According to various embodiments, a retrofit kit for an existing light fixture includes a light trap and a wireless communication module. The light trap is adapted to span a gap between a housing and an optic of the light fixture and includes a wireless communication module support adapted to removably support the wireless communication module on the light trap. The wireless communication module is supported by the wireless communication module support of the light trap.

In some examples, the light trap includes a trim and a sidewall, the wireless communication module support is on the sidewall such that the trim at least partially covers the wireless communication module support and the wireless communication module, and the trim is adapted to at least partially overlap an edge of the optic. In various cases, the wireless communication module support includes a receiving slot defined on an inner surface of the sidewall and a securing arm extending from the inner surface of the sidewall. In certain aspects, the securing arm is deflectable away from the receiving slot, and the wireless communication module is removably supported within the receiving slot and between the securing arm and the inner surface of the sidewall.

In certain examples, the wireless communication module includes an antenna, and the wireless communication module is supported such the antenna of the wireless communication module is substantially perpendicular to the sidewall of the light trap. The wireless communication support supports the wireless communication module such that the antenna is at various other angles in other examples, and need not be supported substantially perpendicular to the sidewall. In various aspects, the trim completely covers the wireless communication module and the wireless communication module support. In some cases, the light trap includes an optic engagement feature adapted to engage the optic of the light fixture and an end plate engagement feature adapted to engage an end plate of the light fixture.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is an exploded assembly view of a light fixture with a housing and a light trap according to aspects of the current disclosure.

FIG. 2 is a front view of the light trap of FIG. 1 supporting a wireless communication module such as a Bluetooth® Low Energy (BLE) module.

FIG. 3 is a back view of the light trap of FIG. 1.

FIG. 4 is a top view of the light trap of FIG. 1.

FIG. 5 is a bottom view of the light trap of FIG. 1.

FIG. 6 is a side view of the light trap of FIG. 1.

FIG. 7 is a partially exploded assembly view of a portion of the light fixture of FIG. 1.

FIG. 8 is another partially exploded assembly view of a portion of the light fixture of FIG. 1.

FIG. 9 is a perspective view of the assembled light fixture of FIG. 1.

FIG. 10 is a perspective view of another example of a light trap supporting a wireless communication module such as a BLE module according to aspects of the present disclosure.

FIG. 11 is another perspective view of the light trap of FIG. 10.

FIG. 12 is a perspective view of the light trap of FIG. 10 without the wireless communication module module.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “left,” “right,” “front,” and “back,” among others are intended to refer to the orientation as illustrated and described in the figure (or figures) to which the components and directions are referencing.

Embodiments of the present invention are directed to light traps that support wireless communication modules for light fixtures, for example modules having the capability to communicate wirelessly according to a BLE, Wi-Fi®, or other standardized or proprietary wireless protocols. The light traps and/or wireless communication modules may be provided either by retrofitting them into existing fixtures or providing them on new (i.e., native) fixtures. Embodiments of the present invention are directed to various ways by which to incorporate light traps and/or BLE wireless communication modules within LED light fixtures, but it will be recognized that the invention may be embodied in light fixtures using other kinds of light sources, for example fluorescent, incandescent, or other kinds of light sources. Embodiments of the present invention are not intended to be limited to the particulars of the light fixtures themselves.

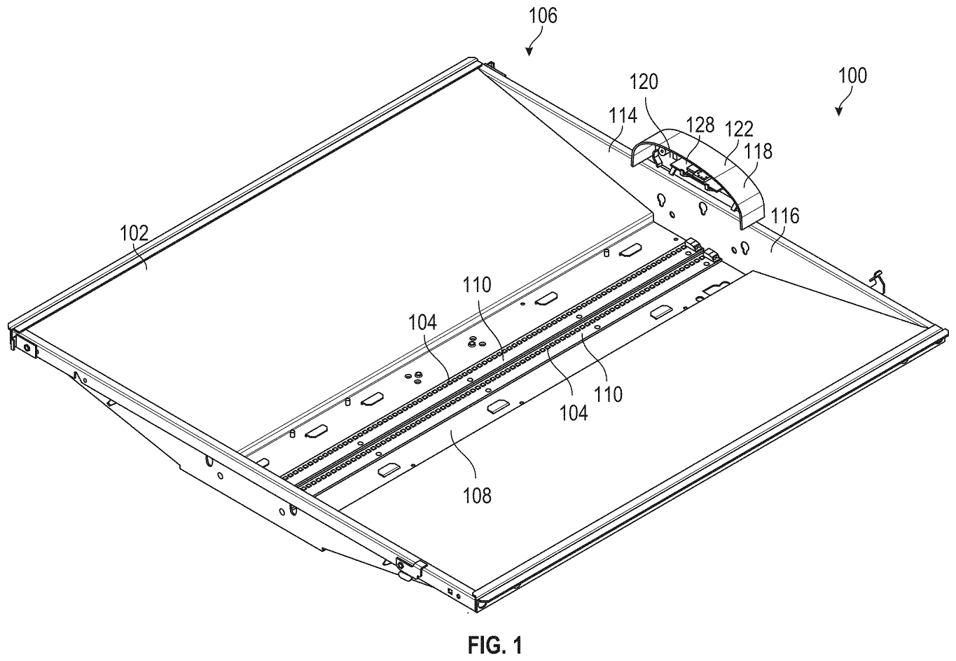

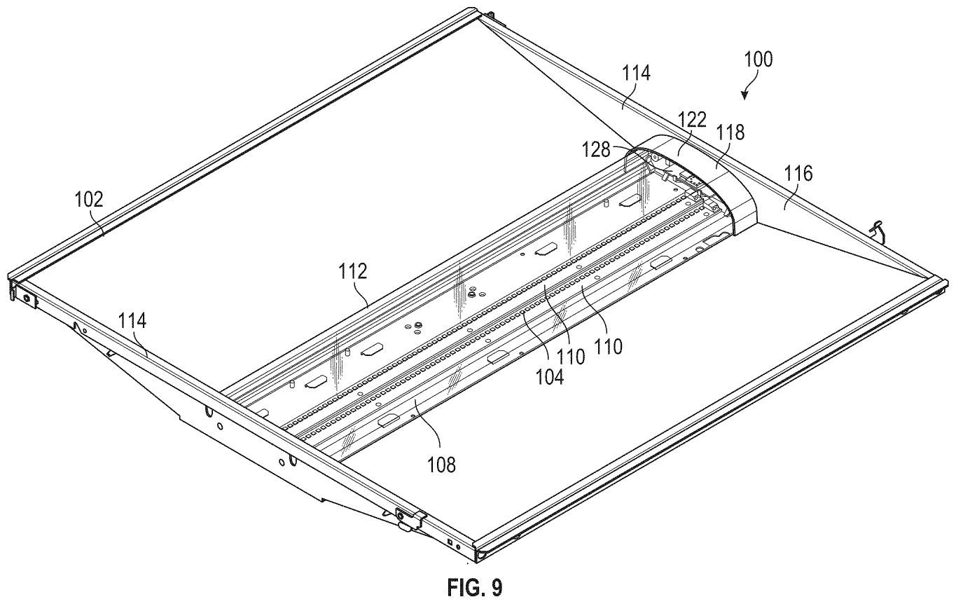

Referring to FIGS. 1 and 9, a light fixture 100 generally includes a reflector or housing 102 with a light source, which may be LEDs 104 or other suitable light sources. The side of the housing 102 with the LEDs 104 is the light emitting side 106 of the light fixture 100, and the side opposite from the LEDs 104 is the non-light emitting side of the fixture 100 (because light is not directed toward that region of the light fixture). The light fixture 100 may commonly be mounted in or on a ceiling with the light emitting side 106 facing downward into the space below, but this is not a requirement, and in the light fixture 100 may be usable in any orientation.

The LEDs 104 are mounted on the housing so as to emit light from the light-emitting side 106 of the light fixture 100. In some examples, the LEDs 104 are mounted on a channel cover 108 that is, in turn, mounted on the housing 102. The LEDs 104 are shown provided on printed circuit boards 110 (“PCB”). In this example, the light fixture 100 includes two PCBs 110 having LEDs 104. However, in other embodiments no PCB 110 is needed; rather, the LEDs 104 are chip-on-board LEDs provided directly on the housing 102 or channel cover 108. In further examples, any number of PCBs 110 may be provided, such as one PCB 110 or more than two PCBs 110. The LEDs 104 may be various types of LEDs including single-die LEDs, multi-die LEDs, direct current (DC) LEDs, alternating current (AC) LEDs, organic light emitting diodes, and/or various other suitable LEDs. White, color, or multicolor LEDs may be used. Moreover, the LEDs 104 need not all be the same color and/or type; rather, mixtures of different colors and/or types of LEDs may be used.

As illustrated in FIG. 9, the light fixture 100 further includes an optic 112 (such as a lens, diffuser, or other suitable optic) provided over the LEDs 104 and positioned on the housing 102. In various examples, the optic 112 may be positioned through various mechanisms such as via snap-fitting onto the channel cover 108 or through various other suitable connection mechanisms to the channel cover 108 or other components of the light fixture 100. The optic 112 can be made of any non-metallic material that permits light to exit through the optic 112, including, but not limited to, polymeric materials, glass, silicone and various other suitable materials for light distribution.

End plates 114 are positioned at the ends of the housing 102. Each end plate 114 has an inner surface 116 that generally faces the LEDs 104 and/or the light-emitting side 106 of the light fixture 100. A driver for driving the LEDs 104 could be provided in various locations on the light fixture 100, such as on an upper surface 14 of the housing 102 (e.g., the surface of the housing on the non-light emitting side of the fixture 100), on the channel cover 108, or various other suitable locations.

It will be appreciated that the shape, configuration, and components of the light fixture 100 should not be considered limiting on the present disclosure as the light fixture 100 may have any desired shape or configuration with fewer or additional components.

In some examples, one or more light traps 118 may be included with the light fixture 100. The light trap 118 may include various shapes or geometries as desired. In certain examples, the shape of the light trap 118 is complementary to a shape of the optic 112, although it need not be in other examples. In various aspects, a light trap 118 is provided between ends of the optic 112 and the end plates 114 to span any gaps between the ends of the optic 112 and the end plates 114 and prevent undiffused light from the LEDs 104 from escaping the light fixture 100. As described in detail below, in various examples, the light trap 118 at least partially overlaps the optic 112 when assembled. In certain aspects, the light trap 118 may provide a uniform edge or end of diffused light from the light fixture 100 when viewed from the light-emitting side 106. In some cases, the light trap 118 may also be provided to enclose the light fixture 100 (e.g., by covering any gaps between components), at least partially support the optic 112 on the light fixture 100, and/or house other electronics for the light fixture 100.

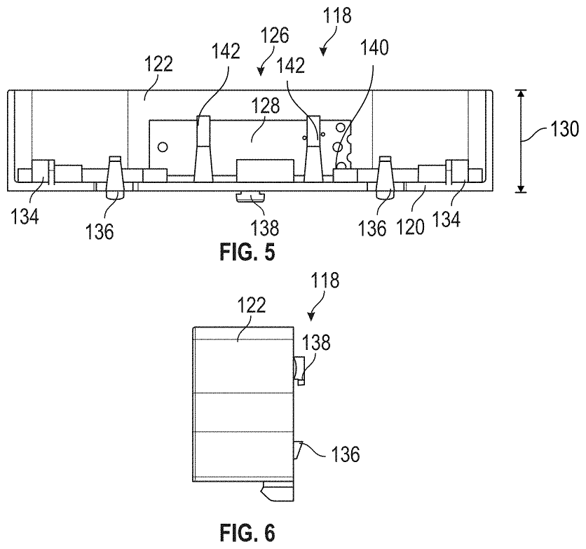

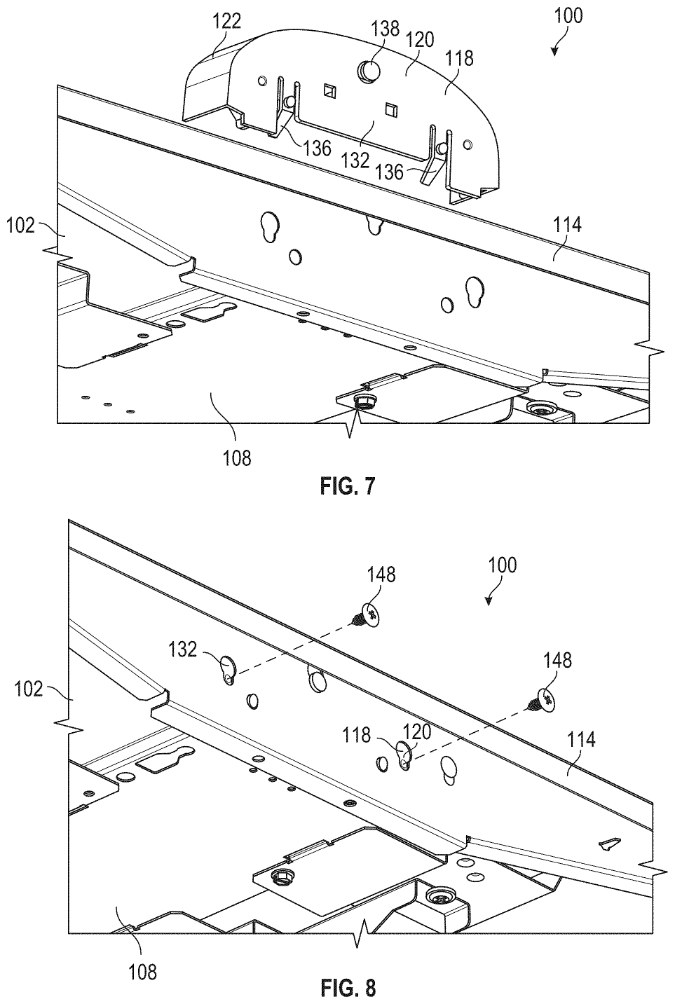

Referring to FIGS. 1-9, the light trap 118 includes a sidewall 120, a trim 122, and a BLE module support 126. In certain aspects, the sidewall 120, trim 122, and BLE module support 126 are monolithically formed as a single, integral unit through various forming techniques such as extrusion, molding, etc. In other examples, the sidewall 120, trim 122, and/or BLE module support 126 are individual components that are attached to the other components of the light trap 118 through various suitable attachment mechanisms including, but not limited to, adhesives, mechanical fasteners, welding, snaps, or various other suitable mechanisms.

The sidewall 120 of the light trap 118 includes an inner surface 124 and an outer surface 132. When assembled with the light fixture 100, the inner surface 124 is the surface adjacent to or nearer to the optic 112, and the outer surface 132 is the surface adjacent to or nearer to the end plate 114. In certain examples, the inner surface 124 may include various optic engagement features 134 that may engage the optic 112 and position the optic 112 relative to the light trap 118. The optic engagement features 134 may be ribs, grooves, channels, pins, screws, snap-fit engagement features, hooks, various combinations thereof, or various other suitable features for engaging and positioning the optic 112 relative to the light trap 118. In the example of FIGS. 1-9, the optic engagement features 134 are ribs that define a channel that receives portions of the end of the optic 112.

The sidewall 120 also may include end plate engagement features 136 that may engage the end plate 114 and position the light trap 118 relative to the end plate 114. In some examples, the end plate engagement features 136 may be ribs, grooves, channels, pins, screws, snap-fit engagement features, hooks, various combinations thereof, or various other suitable features for engaging and positioning the light trap 118 on the end plate 114. In the example of FIGS. 1-9, the end plate engagement features 136 include snap-fit engagement features and screw apertures. The screw apertures engage screws 148 (see FIG. 8). Optionally, the sidewall 120 also includes a guide pin 138 that engages the end plate 114 and centers the light trap 118 with the end plate 114.

The trim 122 extends a predetermined distance away from the inner surface 124 such that the trim 122 has a width 130 (see FIG. 4). In various examples, the trim 122 has the width 130 such that at least a portion of the trim 122 overlaps an edge of the optic 112.

In some examples, the BLE module support 126 is provided on the inner surface 124 of the sidewall 120 of the light trap 118. However, in other examples, the BLE module support 126 may be provided at various other locations on the light trap 118, such as the outer surface 132 and/or the trim 122 of the light trap 118.

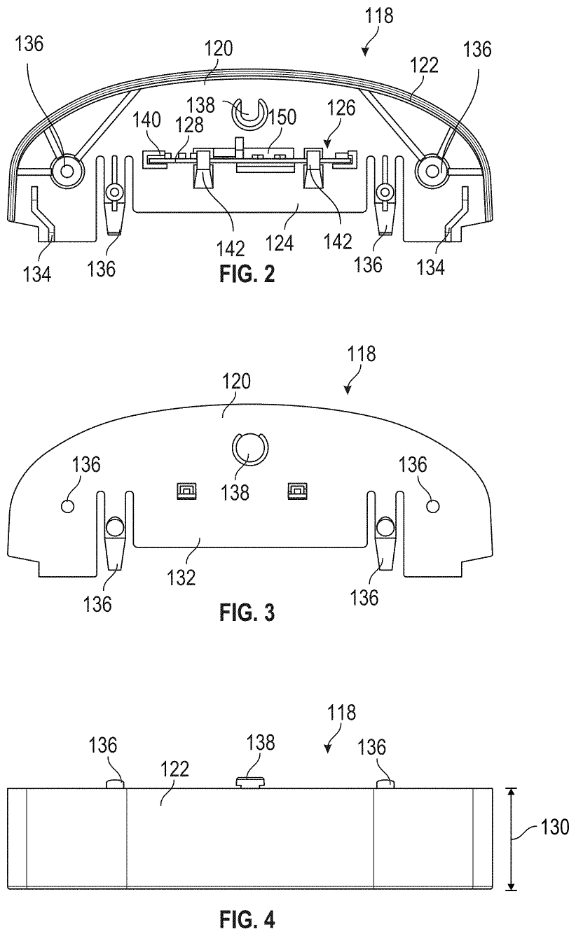

As best illustrated in FIGS. 2 and 5, the BLE module support 126 removably supports a BLE module 128 on the light trap 118. As mentioned previously, while a BLE module is described, in other examples, the module 128 may be various other types of modules having the capability to communicate wirelessly according to a Wi-Fi®, NFC, LiFi, 3G, or other standardized or proprietary wireless protocols.

In certain aspects, and as best illustrated in FIGS. 4 and 5, the BLE module support 126 supports the BLE module 128 such that the trim 122 at least partially covers or overlaps the BLE module support 126 and/or BLE module 128 (when supported). In certain examples, the trim 122 completely covers or overlaps the BLE module support 126 and BLE module 128 when viewed from a plan view. In other examples, the trim 122 may have any suitable width 130 as desired, which may or may not completely cover or overlap the BLE module support 126 and/or the BLE module 128.

In various examples, the BLE module support 126 supports the BLE module 128 such that the BLE module 128 is offset from the inner surface 116 of the end plate 114, surfaces of the housing 102, and/or surfaces of the channel cover 108. Such positioning may allow for wiring to be passed along various components of the light fixture 100 without interfering with the BLE module 128. Such positioning may also provide clearance between metal components (e.g., components of the channel cover 108, end plate 114, housing 102, etc.) and BLE module 128 for optimal radio frequency spread. In other examples, the BLE module support 126 supports the BLE module 128 at various other positions relative to the end plate 114 and/or other components of the light fixture 100.

In some examples, the BLE module 128 has an antenna 150 (see FIG. 2), and the BLE module support 126 supports the BLE module 128 such that the antenna 150 is substantially perpendicular to the sidewall 120. In such configurations, the antenna 150 may be positioned for optimal radio frequency spread and maximum received signal strength indication (RSSI) to a user's smart device. In other examples, the BLE module support 126 supports the BLE module 128 such that the antenna 150 is at various other configurations as desired. For example, in some cases, the BLE module support 126 supports the BLE module 128 at angles less than 90 degrees or greater than 90 degrees relative to the sidewall 120 such that the BLE module 128 is tilted relative to the sidewall 120 and/or relative to an apparent central location in the light fixture. As such, the BLE module support 126 may support the BLE module 128 at a variety of angles which may be less than 90 degrees, about 90 degrees, and/or greater than about 90 degrees.

The BLE module support 126 is configured to removably support the BLE module 128 such that the BLE module 128 may be selectively supported or removed from the light trap 118 (e.g., for maintenance on the BLE module 128, to change BLE modules 128, to remove the BLE module 128, etc.). By removably supporting the BLE module 128, the BLE module support 126 allows for easy access to the BLE module 128 for removal, replacement, maintenance, etc. without requiring a modification to other components of the light fixture 100 and/or replacement of the entire light fixture 100.

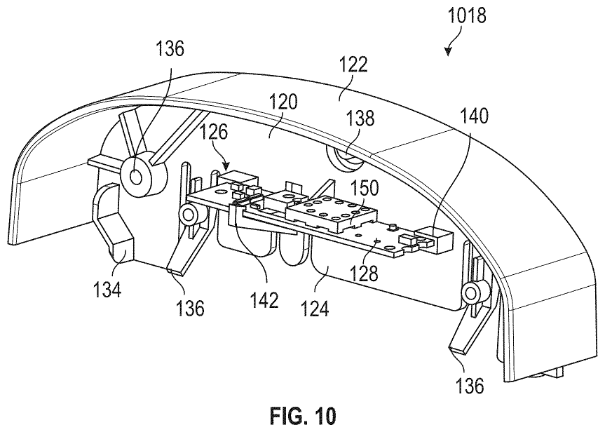

In the example of FIGS. 1-9, the BLE module support 126 includes a receiving slot 140 and a securing arm 142. Although two securing arms 142 are illustrated, any number of securing arms 142 may be provided, such as one securing arm or more than two securing arms. For example, FIGS. 10-12 illustrate an example of a light trap 1018 where the BLE module support 126 includes one securing arm 142.

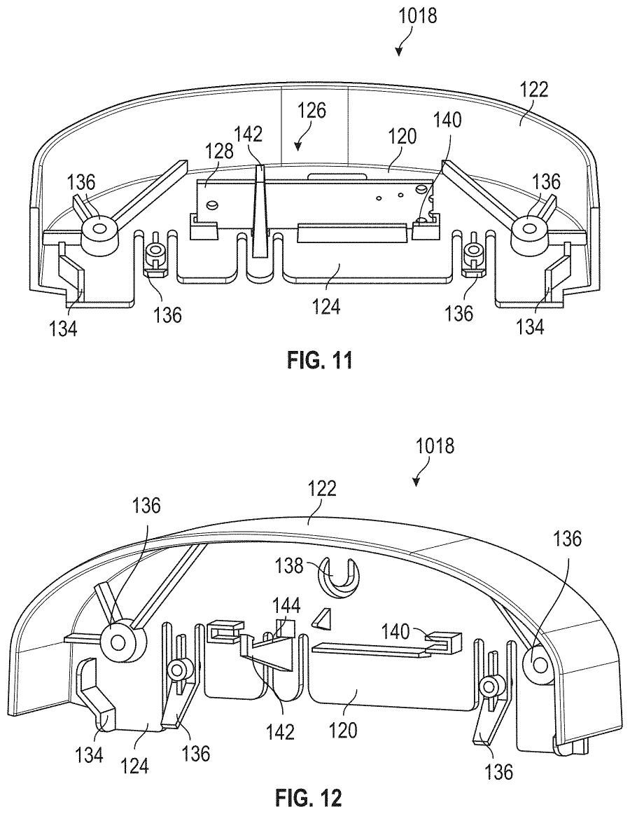

In some examples, the receiving slot 140 extends from the inner surface 124 of the sidewall 120 in the same direction as the trim 122. The securing arm 142 includes a securing arm surface 144 (see FIG. 12) on which the BLE module 128 is positioned when assembled. The securing arm 142 is deflectable away from the receiving slot 140 such that the BLE module 128 can be positioned within the receiving slot 140. Once the BLE module 128 is positioned within the receiving slot 140, the securing arm 142 returns to its un-deflected position and engages an outer edge of the BLE module 128 to retain the BLE module 128 within the receiving slot 140. While the receiving slot 140 and securing arm 142 are illustrated as the BLE module support 126, it will be appreciated that in various other embodiments, various other mechanisms or components may be utilized as the BLE module support 126.

FIGS. 10-12 illustrate another example of a light trap 1018 that is substantially similar to the light trap 118 of FIGS. 1-9 except that the light trap 1018 of FIGS. 10-12 includes a single securing arm 142.

A method of assembling the light fixture 100 with the light trap 118 (or the light trap 1018) is also disclosed. The method includes assembling the light fixture 100 by assembling the housing 102, light source, channel cover 108, and end plates 114 together. The method also includes supporting at least one light trap 118 with one of the end plates 114. In some examples, the at least one light trap 118 is supported such that the outer surface 132 of the light trap 118 abuts the inner surface 116 of the end plate 114. Supporting the at least one light trap 118 may include engaging end plate engagement features 136 with corresponding engagement features on the end plate 114.

In some examples, the at least one light trap 118 is supported with the BLE module 128 pre-installed on the BLE module support 126. In other examples, the BLE module 128 is installed after the at least one light trap 118 is supported on the end plate 114. Installing the BLE module 128 on the BLE module support 126 may include deflecting the securing arm 142 away from the receiving slot 140 and sliding the BLE module 128 into the receiving slot 140. The method may include releasing the securing arm 142 such that the securing arm 142 returns to its un-deflected configuration and engages the edge of the BLE module 128 to retain the BLE module on the light trap 118 and within the receiving slot 140. In various aspects, a power source for the BLE module is included locally on the light trap or other suitable location on the light fixture, and the BLE module is plugged into the power source or otherwise suitably connected to the power source. In other examples, the power source is external to the light trap and/or the light fixture.

In various examples, the method includes installing and supporting the optic 112 on the light fixture 100. In some aspects, installing the optic 112 may include engaging an end of the optic 112 with optic engagement features 134 of the at least one light trap 118. In certain cases, installing the optic 112 includes engaging the optic 112 with the at least one light trap 118 such that the trim 122 of the at least one light trap 118 overlaps the edges of the optic 112. Installing the optic 112 optionally includes engaging the light trap 118 such that the light trap 118 spans a gap between the end of the optic 112 and the housing to prevent undiffused light from the LEDs 104 from escaping from the light fixture 100. Another light trap 118 may be installed on the light fixture 100 (and on the end plate 114 opposite from the other end plate 114 with the installed light trap 118) before the optic 112 is installed or after is installed.

A method of servicing the BLE module 128 of the light fixture 100 includes removing the optic 112 such that the BLE module 128 is accessible. The method includes removing the BLE module 128 from the BLE module support 126. In some examples, removing the BLE module 128 includes deflecting the securing arm 142 away from the receiving slot 140 and away from the BLE module 128 such that the securing arm 142 is not engaged with the edge of the BLE module 128. The method may include sliding the BLE module 128 out of the receiving slot 140. The method may also include unplugging or otherwise disconnecting the BLE module 128 from a power source.

In some examples, the method includes reinstalling the BLE module 128 after servicing and/or installing a new BLE module 128. In certain examples, reinstalling the BLE module 128 includes deflecting the securing arm 142 away from the receiving slot 140 and sliding the BLE module 128 into the receiving slot 140. The method may include releasing the securing arm 142 such that the securing arm 142 returns to its un-deflected configuration and engages the edge of the BLE module 128 to retain the BLE module on the light trap 118 and within the receiving slot 140.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

1. A light fixture comprising:
a housing; and
a light trap supported on the housing and adapted to span a gap between the housing and an optic of the light fixture, wherein the light trap comprises a wireless communication module support on an outer surface of the light trap and adapted to removably support a wireless communication module on the light trap.

2. The light fixture of claim 1, wherein the light trap comprises a trim and a sidewall, wherein the wireless communication module support is on the sidewall, and wherein the trim at least partially covers the wireless communication module support and is adapted to at least partially overlap an edge of the optic.

3. The light fixture of claim 2, wherein the wireless communication module support comprises a receiving slot defined on the sidewall and a securing arm extending from the sidewall.

4. The light fixture of claim 3, wherein the securing arm is deflectable away from the receiving slot.

5. The light fixture of claim 2, wherein the wireless communication module support is adapted to support the wireless communication module such that an antenna of the wireless communication module is substantially perpendicular to the sidewall.

6. The light fixture of claim 1, further comprising:
the wireless communication module;
a pair of end plates;
a light source on the housing between the end plates; and
an optic supported between the end plates and above the light source,
wherein the light trap is supported between at least one end plate of the pair of end plates and the optic.

7. The light fixture of claim 6, wherein the wireless communication module support is offset from an inner wall of the at least one end plate.

8. A light trap for a light fixture, the light trap comprising:
a sidewall comprising an outer surface;
a trim extending away from the outer surface; and
a wireless communication module support on the outer surface of the sidewall and adapted to support a wireless communication module, wherein the wireless communication module support is at least partially covered by the trim.

9. The light trap of claim 8, wherein the wireless communication support comprises a receiving slot defined on the outer surface of the sidewall and a securing arm extending from the outer surface of the sidewall.

10. The light trap of claim 9, wherein the securing arm is deflectable away from the receiving slot.

11. The light trap of claim 8, wherein the light trap is adapted to be positioned on the light fixture between an optic of the light fixture and a housing of the light fixture.

12. The light trap of claim 8, wherein the wireless communication module support is adapted to support the wireless communication module such that an antenna of the wireless communication module is substantially perpendicular to the sidewall.

13. The light trap of claim 8, wherein the sidewall, trim, and wireless communication module support are monolithically formed.

14. The light trap of claim 8, wherein the trim extends a first distance away from the outer surface, wherein the wireless communication module support comprises a receiving slot that extends a second distance away from the outer surface, and wherein the first distance is greater than the second distance.

15. A retrofit kit for an existing light fixture, the retrofit kit comprising:
a light trap adapted to span a gap between a housing and an optic of the existing light fixture, wherein the light trap comprises a wireless communication module support on an outer surface of the light trap and adapted to removably support a wireless communication module on the light trap; and
a wireless communication module supported by the wireless communication module support of the light trap.

16. The retrofit kit of claim 15, wherein the light trap comprises a trim and a sidewall, wherein the wireless communication module support is on the sidewall such that the trim at least partially covers the wireless communication module support and the wireless communication module, and wherein the trim is adapted to at least partially overlap an edge of the optic.

17. The retrofit kit of claim 16, wherein the wireless communication module support comprises a receiving slot defined on the sidewall and a securing arm extending from the sidewall, wherein the securing arm is deflectable away from the receiving slot, and wherein the wireless communication module is removably supported within the receiving slot and between the securing arm and the sidewall.

18. The retrofit kit of claim 16, wherein the wireless communication module comprises an antenna, and wherein the wireless communication module is supported such the antenna of the wireless communication module is substantially perpendicular to the sidewall of the light trap.

19. The retrofit kit of claim 16, wherein the trim completely covers the wireless communication module and the wireless communication module support.

20. The retrofit kit of claim 15, wherein the light trap further comprises an optic engagement feature adapted to engage the optic of the existing light fixture and an end plate engagement feature adapted to engage an end plate of the existing light fixture.
